(19) United States
(12) Patent Application Publication
(10) Pub. No.: US 2005/0078477 A1
(43) Pub. Date: Apr. 14, 2005

(54) Light emitting diode lamp

(76) Inventor: Chin-Feng Lo, Hsin-Tien City (TW)

Correspondence Address: TROXELL LAW OFFICE PLLC, 5205 LEESBURG PIKE, SUITE 1404, Fall Church, VA, 22041, US

(21) Appl. No.: 10/217,757

(22) Filed: Aug. 12, 2002

(51) Int. Cl. F21L 4/04

(52) U.S. Cl. 362/202

(57) ABSTRACT

The present invention is to replace the original light sources with LED lamps in conventional lamp settings designed for fluorescent lamps, incandescent bulbs, and the bulb-based flash lights. It provides an LED lamp, comprising a plurality of LEDs, a circuit board for soldering said LEDs, a connecting base. The circuit board includes a plurality of solder points, each for soldering an LED, and a conductive line to electrically connect the soldered LEDs. The connecting base is electrically connected to the conductive line of said circuit board. The connecting base is also used to mount in the conventional lamp socket and make electrical connection. The connecting base is a column for encompassing the circuit board, wherein said circuit board is shaped according to the shape of the column, and the position of connecting to the column is designed according to the use in the preferred embodiments, such as fluorescent lights, incandescent bulbs, and bulb-based flash lights.

### FIELD OF THE INVENTION

This invention relates to the field of lamp devices for lighting sources, and more particular to a high efficiency lamp employing light emitting diodes (LED).

### BACKGROUND OF THE INVENTION

As the recent development and utilization of high illumination light emitting diodes (LED), it is economically feasible for mass production of these devices. Hence, there have been applications using LEDs as light sources. The prior art shown in FIG. 1 uses a lamp setting designed for incorporating LEDs as the light source for a special flash light. Wherein the LED lamp, due to the restriction of its special structure, cannot be used with other flash lights originally designed for using W bulbs. The present invention provides an LED lamp that can be used directly with the conventional flash lights. In addition, the said LED lamp can also be used in the conventional lamp setting designed for using fluorescent lamps.

### SUMMARY OF THE INVENTION

The goal of the present invention is to replace the original light sources with LED lamps in conventional lamp settings designed for fluorescent lamps, incandescent bulbs, and the bulb-based flash lights.

To achieve the aforementioned purpose, the present invention provides an LED lamp, comprising a plurality of LEDs, a circuit board for soldering said LEDs, a connecting base. The circuit board includes a plurality of solder points, each for soldering an LED, and a conductive line to electrically connect the soldered LEDs. The connecting base is electrically connected to the conductive line of said circuit board. The connecting base is also used to mount in the conventional lamp socket and make electrical connection. The features of the connecting base is a column for encompassing the circuit board, wherein said circuit board is shaped according to the shape of the column, and the position of connecting to the column is designed according to the use in the preferred embodiments, such as fluorescent lights, incandescent bulbs, and bulb-based flash lights.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a prior art of a flash light using LED lamps.

FIG. 2 shows the circuit of the present invention.

FIG. 3 shows a printed circuit board of the circuit embodiment.

FIG. 4 shows the first embodiment of the circuit shown in FIG. 2.

FIG. 5 shows the second embodiment of the circuit shown in FIG. 2.

FIG. 6 shows the another variation of the second embodiment shown in FIG. 5.

FIG. 7 shows the front view of the connecting base in the embodiments shown in FIGS. 4, 5 and 6.

FIGS. 8A to 8E show the front view of the connecting base used in different lamp setting in the present invention.

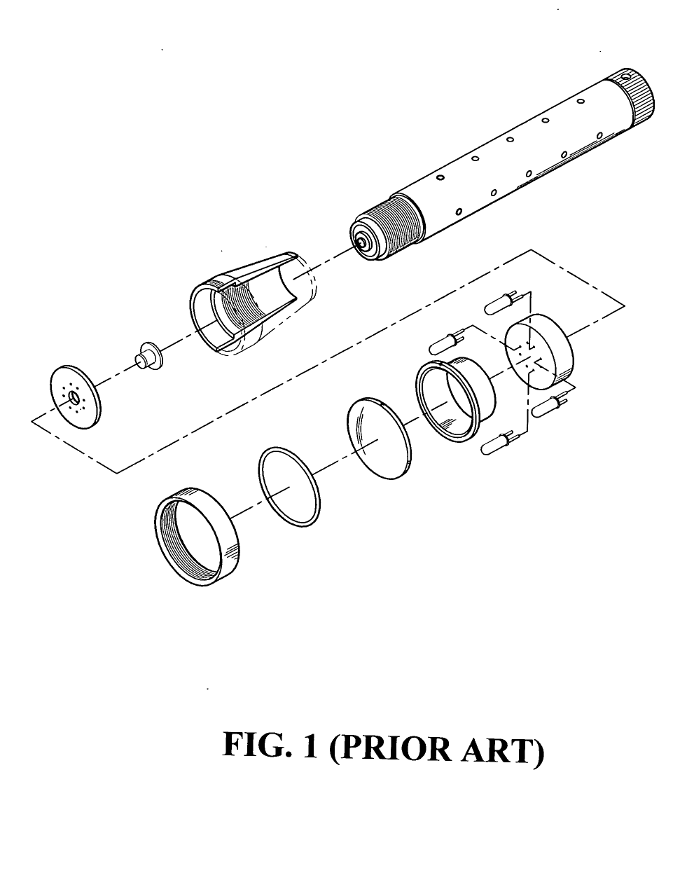

### DETAILED DESCRIPTION OF THE INVENTION

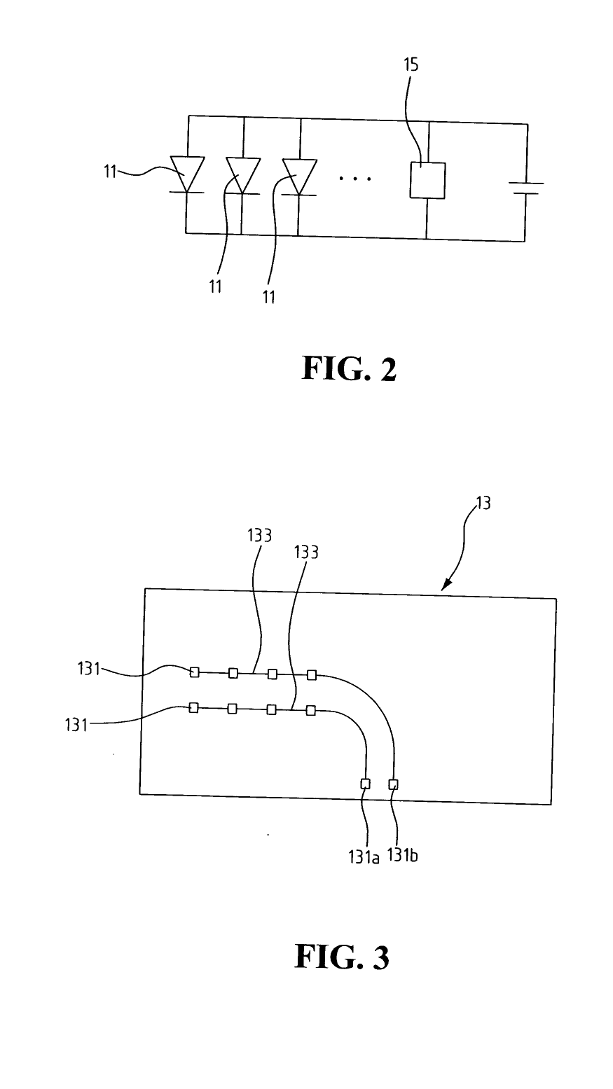

FIG. 2 shows the circuit diagram of the present invention. A plurality of LEDs 11 are electrically connected in parallel, wherein the parallel connection circuit is formed on circuit board 13. For example, the circuit board 13 can be a printed circuit board, as shown in FIG. 3. By etching the cobber foil on the printed circuit board, a circuit board 13 with a plurality of solder points 131 and a conductive line 133 can be realized. Each solder point 131 is soldered with an LED 11, and the conductive line 133 electrically connects all the LED 11 in parallel. The solder points 131a and 131b are used to electrically connect to the connecting base 15. The connecting base 15 is used to mount the conventional lamp socket. Hence, it is designed to be compatible to the standard lamp socket specification so that it can replace the conventional lamps.

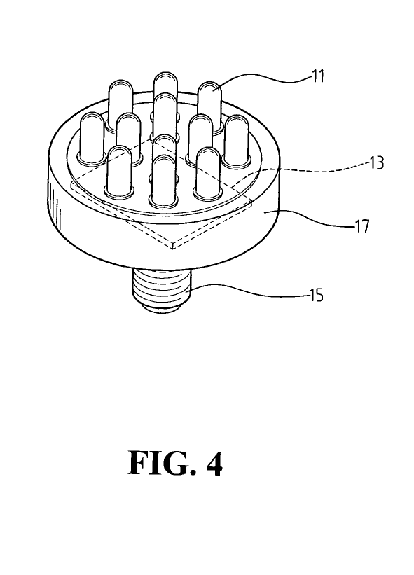

The distinct features of present invention is to use a column 17, as shown in FIGS. 4, 5, and 6, to encompass the circuit board 13, wherein the said circuit 13 is shaped according to the column. The position of the connecting base 15 on the column 17 depends on the preferred embodiments, such as fluorescent lamps, incandescent bulbs, and bulb-based flash light.

FIGS. 4, 5, and 6 show the present invention in the different embodiments, wherein the connecting base uses standard spiral head for mounting the standard lamp sockets.

FIG. 4 shows the first embodiment of the circuit shown in FIG. 2. It is an embodiment of the present invention in the bulb-based light sources, including the regular incandescent bulbs and the bulb-based flash light. The column 17 in this embodiment has the shape of a short cylinder column. The circuit board 13 is accordingly shaped as a flat plate, horizontally housed in the column 17. The connecting base 15 is located at the bottom of the column 17, so the physical structure of the embodiment is similar to that of the conventional regular incandescent bulbs, or flashlight bulbs.

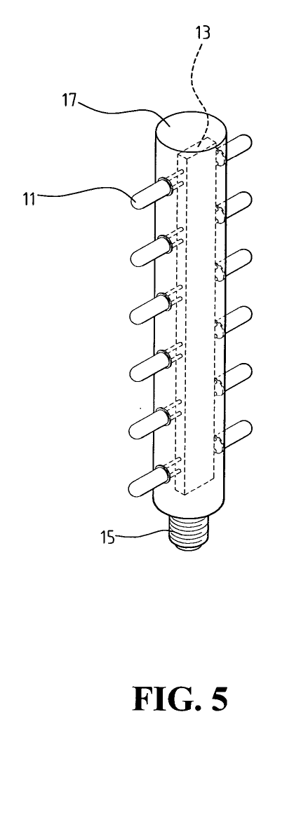

FIG. 5 shows the second embodiment of the circuit shown in FIG. 2. It is an embodiment of the present invention in the fluorescent light sources, for example, to replace the existing fluorescent tubes. The column 17 in this embodiment has the shape of a long cylinder tube. The circuit board 13 is accordingly shaped as a long strip, vertically housed in the column 17. The connecting base 15 is located at the bottom of the column 17, so that the physical structure of the embodiment is similar to that of a conventional fluorescent light source.

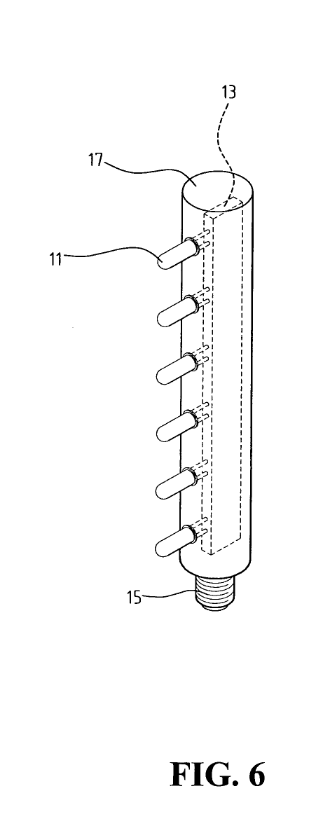

FIG. 6 shows a variation of the embodiment shown in FIG. 5. The difference lies in that the LEDs are placed on one side only in this design.

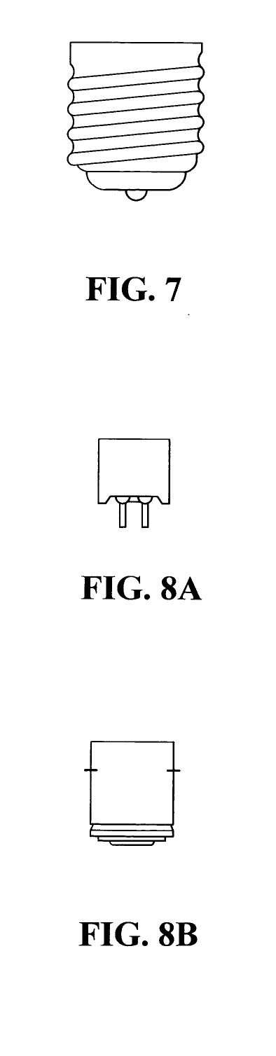

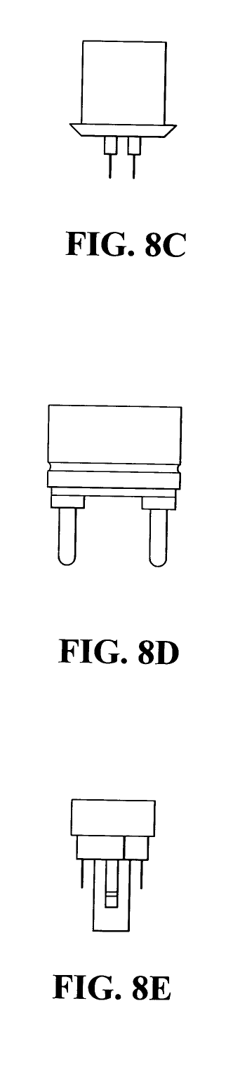

FIG. 7 shows the front view of the connecting base in the embodiments of FIGS. 4, 5, and 6. FIGS. 8A to 8E show the front view of the embodiments of the connecting base used in other types of socket settings. The column 17 used in the present invention can be made of plastic to form various transparent or non-transparent shapes.

Compared to the prior arts, the present invention of LED lamps has the following advantages:
1. As LEDs are energy efficient and highly illuminant, the present invention can save energy as a long term light source.
2. The present invention can replace the conventional mercury tube as lighting sources, and be more environmentally friendly.
3. As lighting sources, the present invention produces less heat, therefore, it can avoid fire caused by overheating.
4. The present invention uses the compatible connecting base. Consumers can use LED lamps in the original lighting facility.

While we have shown and described the embodiment in accordance with the present invention, it should be clear to those skilled in the art that further embodiments may be made without departing from the scope of the present invention.

1. A light emitting diode lamp, comprising:
a plurality of LEDs;
a circuit board with a plurality of soldering points and a conductive line, each said soldering point soldered with a said LED, and all said LEDs electrically connected in parallel by the conductive line;
a connecting base, electrically connected to said conductive line, used to mount the lamp socket in regular lighting facilities;
wherein the said connecting base has a column shape designed to encompass said circuit board, and the position of the connecting base is compatible to the light facilities it mounts.

2. The LED lamp claimed as in claim 1, wherein said column has the shape of long tube, the said circuit board is a strip vertically housed in said tube, and the position of said connecting base is at the bottom of said tube to form a tube light source.

3. The LED lamp claimed as in claim 2, wherein said strip circuit board has a plurality of solder points and a conductive lines along both sides of said circuit board.

4. The LED lamp claimed as in claim 2, wherein said strip circuit board has a plurality of solder points and a conductive line along one side of said circuit board.

5. The LED lamp claimed as in claim 1, wherein said column has the shape of short cylinder column, the said circuit board is a flat plate horizontally housed in said column, and the position of said connecting base is at the bottom of said column to form a light source similar to an incandescent bulb or flash light.
